(19) United States
(12) Patent Application Publication
(10) Pub. No.: US 2016/0205265 A1
(43) Pub. Date: Jul. 14, 2016

(54) SYSTEM FOR CHARGING A USER IN REAL TIME FOR PURCHASING CONTENT WITHOUT DATA NETWORKS

(71) Applicant: Sekhar Rao Balaga, Bangalore (IN)

(72) Inventors: Sekhar Rao Balaga, Bangalore (IN); Ravikanth Ponduri Sri, Bangalore (IN)

(21) Appl. No.: 14/990,364

(22) Filed: Jan. 7, 2016

(30) Foreign Application Priority Data
Jan. 8, 2015 (IN) 135/CHE/2015

(51) Int. Cl. H04M 15/00; H04L 29/08; H04W 4/24

(52) U.S. Cl. CPC H04M 15/49; H04W 4/24; H04M 15/64; H04L 67/02

(57) ABSTRACT

Embodiments herein provide a method and system for charging a user to purchase the content, when the user accesses the online content to purchase the online content though a communication network other than data communication of an operator. The method includes extracting a Mobile Station International Subscriber Directory Number (MSISDN) by a server. The method includes obtaining an explicit consent from the user by a charging server for the purchase of the online content before initiating the charging procedure. Further, the method includes charging the user based on the charging procedure.

### FIELD OF INVENTION

This application claims the benefit of Indian Complete Application No. 135/CHE/2015, filed on Jan. 8, 2015. The present invention relates to a method and system for charging a user in real time for purchasing content.

### BACKGROUND OF INVENTION

The proliferation of communication devices, such as mobile phones, smart phones, tablets, and other such devices, offers an additional level of convenience for users desiring to purchase goods and services online. Several companies provide online websites at which users can purchase online content (for example, songs, music, videos, books and so on). Generally, such websites insist a user to create an account with an online content provider and provide account credentials to charge the user to deliver the selected online content.

In existing system, when the user wishes to purchase content through a Wireless Application Protocol (WAP) portal/Web portal using data connectivity on the communication device, the user selects the online content to purchase. Based on the selected content the network operator will charge the user to purchase the selected content. Further, the user need to provide account credential to retrieve the selected content or the user may be charged through mobile payment services offered by the network operator. In some scenarios, the mobile device of the user connects to the WAP portal server/Web server through Wireless Fidelity (Wi-Fi) connection. In this case, the content provider cannot able to identify the MSISDN in the mobile device and user needs to enter a mobile number in order to purchase the selected content from a Wireless Application Protocol (WAP) server or a web server.

As the Wi-Fi hotspots are being predominantly used in present day scenarios for retrieving the content, it creates cumbersome experience to the user to enter the MSISDN every time when the user desires to purchase the content. Further, the user may be confused, when the content provider requests the user to input the MSISDN of the mobile device, as the user may feel that MSISDN is not captured despite connected to the network through Wi-Fi for data connection.

### OBJECT OF INVENTION

The principal object of the embodiments herein is to provide a method and system that provides a charging mechanism for charging a user to purchase the content, when a user accesses the content through a communication network other than data communication of a mobile network operator.

### SUMMARY

Accordingly the embodiments herein provide a system for charging a user to purchase content. The system comprises an agent, a content provider server, a communication device, a Mobile Switching Center (MSC) and a server. The server is configured to extract a Mobile Station International Subscriber Directory Number (MSISDN) of a communication device. The communication device accesses a content provider server to purchase the content through a communication network other than data communication of an operator of the communication device. The server is configured to obtain a confirmation from the user to purchase the content and initiate a charging procedure with one of the MSC of the MSISDN and at least one interface after obtaining the confirmation from the user. Further, the server is configured to charge the user based on the charging procedure.

Accordingly the embodiments herein provide a method of charging a user for purchasing content. The method comprising extracting a Mobile Station International Subscriber Directory Number (MSISDN) of a communication device by a server. The communication device accesses a content provider server to purchase the online content through a communication network other than data communication of an operator of the communication device. Further the method comprises obtaining a confirmation from the user to purchase the content and initiating a charging procedure with one of a Mobile Switching Center (MSC) of the MSISDN, and at least one interface after obtaining the confirmation from the user. Furthermore, the method comprises charging the user the based on the charging procedure.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 shows a high level overview of a system for charging a user to purchase content, according to the embodiments as disclosed herein;

FIG. 2 illustrates an architecture of a system for charging the user to purchase the content, according to the embodiments as disclosed herein;

FIG. 3 is a flow diagram illustrating a method of charging a user for purchasing the content, according to the embodiments as disclosed herein;

FIG. 4 illustrates a block diagram with various modules in the server, as disclosed in the embodiments herein;

FIG. 5 illustrates a block diagram of a content provider server, according to embodiments as disclosed herein;

FIG. 6 is a sequence diagram illustrating a procedure of charging the user to purchase the content, according to the embodiments as disclosed herein; and

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The embodiments herein achieve a method and system for charging a user to purchase content, when the user accesses the content through a communication device though a wireless communication network, other than data network of an operator. In an embodiment, the wireless communication network is a Wireless Fidelity (Wi-Fi) network/Internet Service Provider (ISP).

The method includes extracting a Mobile Station International Subscriber Directory Number (MSISDN) of the communication device by a server. The method includes obtaining an explicit consent from the user by the server for purchasing the content before initiating a charging procedure. The method includes initiating the charging procedure with a Mobile switching center (MSC) of the MSISDN for charging the user. Further, the method includes charging the user based on the charging procedure.

In an embodiment, the method includes initiating the charging procedure with one or more interfaces by the server for charging the user. In an embodiment, the one or more interfaces include but may not be limited to Global System for Mobile Communications Association (GSMA) One Application Programming Interface (One API), Hyper Text Transfer Protocol (HTTP), Internet Protocol (IP), Voice Extensible Markup Language (VXML), Call Control XML (CCXML), Telecom Web Services Server (TWSS), Third Party Consent Gateways (TPCGs), Service Delivery Platform (SDP), User Communication Integration Protocol (UCIP), charging gateways, financial services (for example: e-commerce, m-commerce and so on), mobile payment gateway, online banking, online wallet, mobile wallet and cash cards and the like.

In an embodiment, the server initiates charging procedure with other Signaling System No. 7 (SS7) protocols such as intelligent network application protocol (INAP), Mobile Application Part (MAP)/CAMEL Application Part (CAP), Diameter, Remote Authentication Dial-In User Service (RADIUS) and the like.

In an embodiment, the agent is present in the content provider server. Further, the agent communicates with the content provider server, the server and the communication device.

In an embodiment, the agent continuously monitors delivery of the content the content provider server to the user.

In an embodiment, the content provider server can be either a Wireless Application Protocol (WAP) server or a Web server.

For a brief discussion of the charging procedure, a reference is made to U.S. Pat. No. 8,781,440 B2 (Nov. 5, 2012), entitled “A real time charging mechanism to deliver on demand telecommunication services”.

Unlike conventional system, the proposed method provides an enhanced user experience in purchasing the content in a Wireless Application Protocol (WAP) portal/Web portal through the communication network other than data communication of the operator. Further, the user need not have to enter the mobile number for purchasing the content as opposed to the conventional system.

The term content refers to any content or service or virtual goods or boosters or a product and the like.

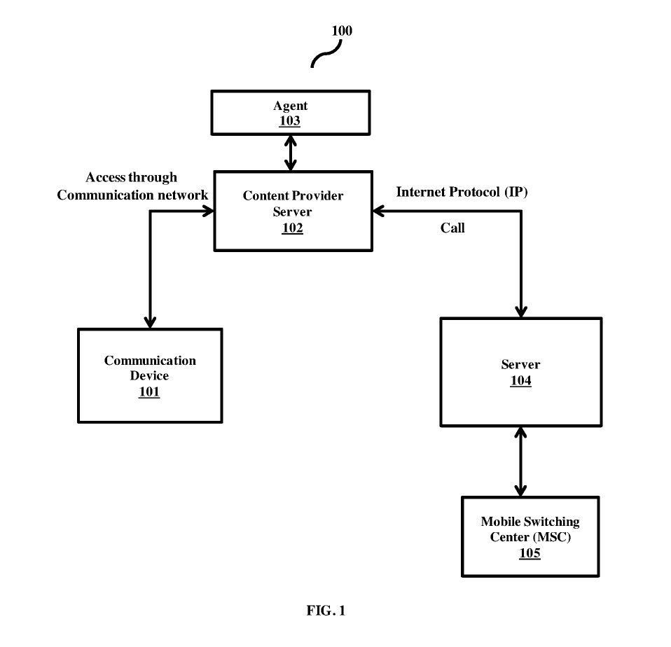

Referring now to the drawings and more particularly to FIGS. 1 to 6, where similar reference characters denote corresponding features consistently throughout the figures, there are shown preferred embodiments.

FIG. 1 shows a high level overview of a system for charging a user to purchase the content, according to the embodiments as disclosed herein. The system 100 comprises a communication device 101, a content provider server 102, an agent 103, a server 104, and a Mobile Switching Center (MSC). The content provider server 102 includes an agent 103. The agent 103 includes sequence of instructions includes but may not be limited to Extensible Hypertext Markup Language (XHTML), JavaScript and the like. The agent 103 can be configured to communicate with the server 104, the content provider server 102 and the communication device 101. The communication device 101 accesses the content from the content provider server 102 through a communication network such as the communication network other than the data communication of the operator.

In an example, the user of the communication device 101 can access the content through the WAP portal/Web portal of the operator using the Wi-Fi. The content provider server 102 provides the content for example, wallpaper, multimedia and so on to the user. In an embodiment, the method receives an event on the content from the user of the communication device. In an example, the event is a touch input or a voice input to select the content. When the user selects the content and clicks on call or a buy option, the communication device 101 triggers a charging call to the server 104.

In an embodiment, the server 104 extracts the MSISDN of the communication device 101 through the charging call. In an embodiment, the server 104 extracts the MSISDN of the communication device 101 through SMS, Unstructured Supplementary Services Data (USSD), Internet Protocol (IP), Voice over Internet Protocol (VoIP) and the like.

In an embodiment, the server 104 extracts details related to the selected content such as type of content, charge associated with the selected content and the like along with the MSISDN. In an embodiment, the agent 103 obtains the details of the user selected content such as type of content, charge associated with the selected content. Further, the agent 103 sends the user selected content to the server 104 through internet protocol (IP).

In an embodiment, the communication device 101 can send a purchase request for purchasing the content by providing the call or the buy option as an interface, which is displayed to the user on the WAP portal/Web portal. When the user clicks on the call or buy option (which is provided to the user through the API, the communication device 101 dials a special number and the purchase request initiated by the user is redirected to the server 104 through the MSC 105. In an embodiment, the communication device 101 dials a Voice over Internet Protocol (VoIP) call, when the communication device has the Wi-Fi connection and the purchase request is redirected to the server 104. The communication device 101 triggers the charging call to the server 104 through the MSC 105. The server 104 extracts the MSISDN of the communication device 101 through the charging call.

In an embodiment, the server 104 may correlate the extracted MSISDN, details of the selected content from the communication device 101 and details obtained from the agent 103 before initiating the charging procedure.

The server 104 provides the charging information related to the selected content to the user of the communication device 101, upon receiving the charging call from communication device 101. In an example, the server 104 requests the user to confirm the purchase of the selected content by providing the charging information to the user. In an embodiment, the charging information can be provided through an audio, push message, USSD, popup message and the like. In an embodiment, the charging information can be provided to the user by displaying the charging information to the user on the communication device 101.

In an embodiment, the charging information can be provided to the user by announcing the charging information to the user on the communication device 101.

In an embodiment, the server 104 requests the user to provide consent or confirmation to purchase the content by providing the charging information for the selected content. In an embodiment, the communication device 101 on receiving the charging information from the server 104 invokes a dialer keypad to receive the consent or confirmation from the user. In an example, the user provides the input, as announced by the server 104 to confirm the selected content and the charging information. In an example, the server 104 requests the user to input a digit or combinations of the digits as a confirmation to purchase the content.

In an embodiment, the server 104 requests the consent from the user for the purchase by means of DTMF tones, Voice input (Biometric), USSD, One time Password (OTP), SMS, and so on. In an embodiment, the user may create his/her own Personal Identification Number (PIN) for providing the confirmation to the purchase. In an embodiment, the user may be provided with a default PIN by the server 104 for confirming the purchase.

In an embodiment, the server 104 requests the consent from the user by displaying a WAP/Web page, where the user can provide the input as displayed on the WAP/Webpage.

When the server 104 receives the confirmation from the user for purchasing the content, the server 104 makes a special charge call with signaling that comprises mobile number of the user and a charge number to the MSC 105 through ISDN User Part (ISUP) protocol/Internet Protocol (IP). For example, the network nodes may include the SDP, an Intelligent Network (IN), a prepaid platform or the like. The charging server 104b processes the service charging request in coordination with the network operator for charge deduction. In an embodiment, the charge number in the signaling message contains a unique address for a node (Signaling Point, SP). After receiving the mobile number and the charge number, the network operator processes the charging request in coordination with the server 104.

The network operator deducts the balance according to the subscription of the user using the standard charging mechanism. The subscription refers to prepaid and post paid subscription. The server 104 acts as a communication platform that communicates with the network operators or MSCs for deducting charge of the selected content.

In an embodiment, the server 104 can initiate the charging procedure with the one or more interfaces by the server for charging the user. In an embodiment, the one or more interfaces include but may not be limited to GSMA One API, HTTP, IP, VXML, CCXML, TWSS, TPCGs, SDP, UCIP, charging gateways, financial services (e-commerce and m-commerce), mobile payment gateway, online banking, online wallet, mobile wallet and cash cards and the like.

In an embodiment, the server initiates charging procedure with other SS7 protocols such as INAP, MAP/CAP, Diameter, RADIUS and the like.

In an embodiment, the agent 103 can be configured to monitor delivery of the content from the content provider server 102 to the user.

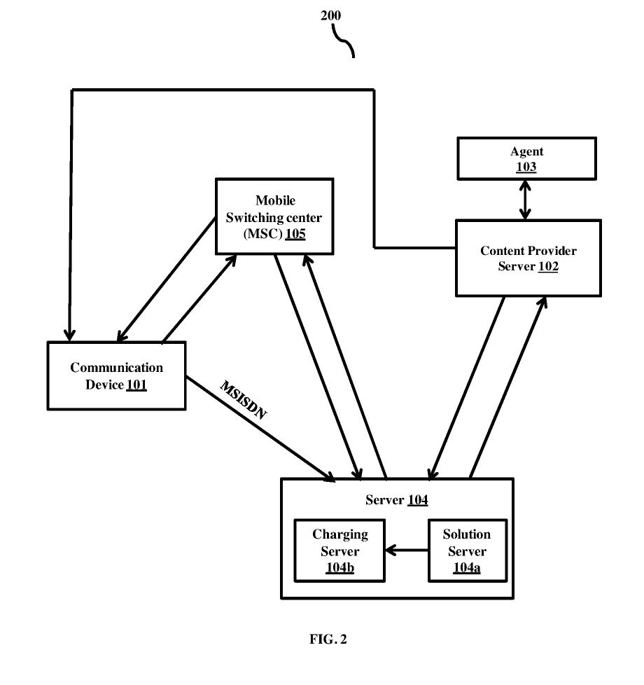

FIG. 2 illustrates architecture of a system for charging a user to purchase the content, according to the embodiments as disclosed herein. As depicted in the FIG. 2, the architecture 200 includes the communication device 101, the content provider server 102, the agent 103, the server 104 and the MSC 105. The communication device 101 may include, but are not limited to, a mobile phone, a tablet, a smart phone and the like.

The server 104 includes a solution server 104a and a charging server 104b. The charging server 104b presents within the server 104 acts as a central entity that integrates with a variety of content providers for purchasing the content by the user.

The communication device 101 accesses the content, from the content provider server 102 through a communication network such as the communication network other than the data communication of the operator. In an example, the user of the communication device 101 can access the content through the WAP portal/Web portal of the operator using the Wi-Fi. The content provider server 102 provides the content, for example, wallpaper, multimedia content and so on to the user.

In an embodiment, when the user selects the content and clicks on the buy option, the communication device 101 triggers the charging call to the server 104. When the server 104 receives the charging call, the server 104 extracts the MSISDN of the communication device 101 through the charging call.

In an embodiment, the server 104 can also extracts the MSISDN of the communication device 101 by means of SMS, USSD, IP, VoIP and the like, triggered by the communication device 101 to the server 104.

In an embodiment, the communication device 101 can send a purchase request for purchasing the content by providing a call or a buy option as an interface, which is displayed to the user on the WAP portal/Web portal. When the user clicks on the call or buy option (which is provided to the user through the API), the communication device 101 dials a special number and the purchase request initiated by the user is redirected to the server 104 as the charging call through the MSC 105. In an embodiment, the communication device 101 dials the VoIP call and the purchase request is redirected to the server 104. The communication device 101 triggers the charging call to the server 104 through the MSC 105. The server 104 receives the charging call from the communication device 101 and allows the solution server 104a to provide the charging information related to the selected content to the user of the communication device 101.

The content provider server 102 obtains the user selected content such as type of content, charge associated with the selected content. Further, the content provider server 102 sends the user selected content to the server 104.

In an embodiment, the server 104 can be configured to correlate the extracted MSISDN and the details of the selected content from the communication device 101 and the details of the content obtained from the agent 103 before initiating the charging procedure.

The server 104 provides the charging information related to the selected content to the user of the communication device 101, upon receiving the charging call from communication device 101. In an example, the server 104 requests the user to confirm the purchase of the selected content by announcing the charging information to the user. In an embodiment, the charging information can be announced through an audio, push message, USSD, popup message and the like. In an embodiment, the charging information can be provided to the user by displaying the charging information to the user on the communication device 101.

In an embodiment, the solution server 104a requests the user to provide the consent or confirmation to purchase the content by announcing or displaying the selected content and the charging information of the selected content. In an example, the solution server 104a announces or displays the selected content and allows the user to input a unique number for purchasing the service through the application.

In an embodiment, the communication device 101 on receiving the announcement from the server 104, can invoke the dialer keypad to receive the consent or confirmation from the user, where the user provides the input, as announced by the solution server 104a to confirm the selected content and the charging information. In an example, the server 104 requests the user to input a digit ‘X’ as a confirmation to purchase the content.

In an embodiment, the solution server 104a requests the consent from the user for the purchase by means of DTMF tones, Voice input (Biometric), USSD, OTP, SMS, pop up message and so on. In an embodiment, the user may create his/her own Personal Identification Number (PIN) for providing the confirmation to the selected content for purchase. Further, the user may be provided with a default PIN for confirming the purchase.

In an embodiment, the server 104 requests the consent from the user by displaying a WAP/Web page, where the user can provide the input as displayed on the WAP/Webpage.

In an embodiment, the solution server 104a requests the consent from the user by playing an announcement for the user to enter the Personal Identification Number (PIN) to confirm the selected content for purchase. For example, when the user is identified as a frequent user (the frequent user is the user who avails the service/content frequently), the solution server 104a plays announcement to the frequent user to enter the PIN to confirm the selected content for purchase. In an embodiment, the frequent user may create his/her own PIN, which is required for providing the confirmation to the selected content. In an embodiment, a default PIN may be provided to the user for confirming the selected content.

When the solution server 104a receives the confirmation from the user for purchasing the content, the solution server 104a sends a service charging request to the charging server 104b. Further, the charging server 104b makes a special charge call with signaling that comprises mobile number of the user and the charge number to the MSC 105 through ISUP protocol/IP. After receiving the mobile number and the charge number, the network operator processes the charging request in coordination with the charging server 104b.

The network operator deducts the balance according to subscription of the user using the standard charging mechanism for prepaid and post paid subscription.

In an embodiment, the charging server 104b may be able to authenticate the user of the communication device 101 before performing charge deduction. Further, the server 104 acts as a communication platform that communicates with the network operators or MSCs for performing the charge deduction.

When the charge deduction is completed, the solution server 104a communicates the charge deduction to the content provider server 102 (for example, a WAP server or a web server). In an example, upon completion of the charge deduction, the solution server 104a communicates the charge deduction to the content provider server through WAP/IP. The content provider server 102 delivers the selected content to the user. In an embodiment, the agent 103 can be configured to monitor delivery of the content from the content provider server 102 to the user.

In an embodiment, the charging server 104b can support the one or more interfaces which include but may not be limited to GSMA One API, HTTP, IP, VXML, CCXML, TWSS, SDP, UCIP, TPCGS, charging gateways, financial services, mobile payment gateway, online banking, online wallet, mobile wallet and cash cards and the like.

In an embodiment, the charging server 104b can initiate the charging procedure with other SS7 protocols such as INAP, MAP/CAP, Diameter, RADIUS and the like.

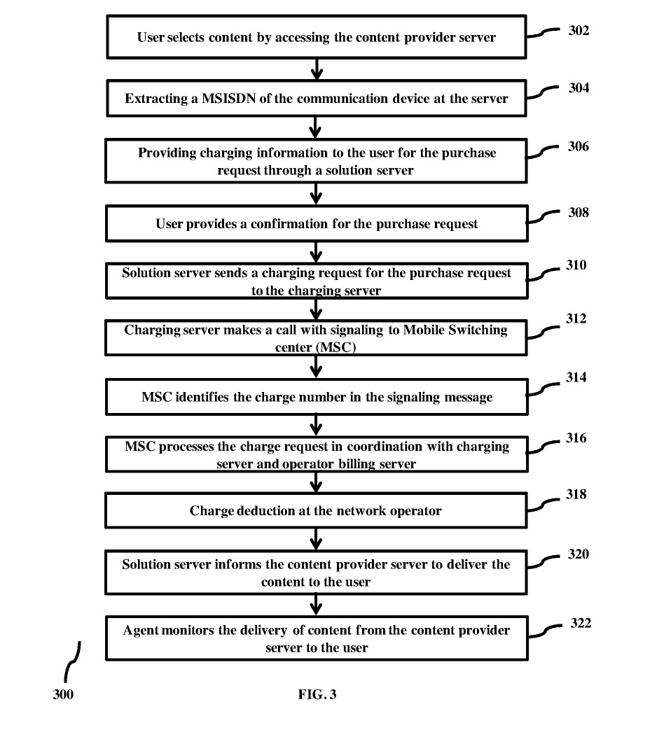

FIG. 3 is a flow diagram illustrating a method 300 of charging a user for purchasing the content, according to the embodiments as disclosed herein. The user accesses the content from the content provider server 102 through a communication network such as communication network other than the data communication of the operator. In an embodiment, the communication network is the Wi-Fi network/ISP.

The user selects (302) the content by accessing the content provider server 102 on the communication device 101.

When the user selects the content to purchase and clicks on the call or buys option, the communication device 101 triggers the charging call to the server 104. The server 104 receives the charging call and extracts (304) the MSISDN of the communication device 101.

In an embodiment, the communication device 101 can send a purchase request for purchasing the content by providing the call or the buy option as an interface, which is displayed to the user on the WAP portal/Web portal. When the user clicks on the call or buy option (which is provided to the user through the API), the communication device 101 dials a special number and the purchase request initiated by the user is redirected to the server 104 through the MSC 105. In an embodiment, the communication device 101 dials the VoIP call and the purchase request is redirected to the server 104. The communication device 101 triggers the charging call to the server 104 through the MSC 105. The server 104 receives the charging call from the communication device 101 and after extraction of the MSISDN, the information of the selected content, the server 104 allows the solution server 104a to provide (306) the charging information related to the selected content to the user of the communication device 101.

In an embodiment, the solution server 104a requests the user to provide the consent or confirmation to purchase the content by announcing the selected content and the charging information of the selected content on the call. In an embodiment, the solution server 104a requests the user to provide the consent or confirmation to purchase the content by displaying the WAP/Web page, where the user has to input the digits displayed on the webpage.

In an embodiment, the charging information can be provided through the audio, push message, USSD and the like.

In an example, the solution server 104a provides the charging information and allows the user to input a unique number for purchasing the selected content. In an embodiment, the user may create his/her own PIN for providing the confirmation to the selected content. Further, the user may be provided with a default PIN for confirming the selected content for purchase.

In an embodiment, the solution server 104a requests the consent from the user by playing an announcement for the user to enter a Personal Identification Number (PIN) to confirm the selected content for purchase, when the user is identified as the frequent user (the frequent user is the user who avails the service/content frequently) at the server 103.

The user provides (308) the consent to avail the requested purchase by inputting the unique number which is associated with the purchase. In an embodiment, the user provides the confirmation to the requested purchase by pressing DTMF inputs through Voice Input (Biometric), USSD, OTP, SMS, Internet Protocol (IP) and so on. In an embodiment, the frequent user may provide the created PIN to confirm the selected content for purchase, in response to the announcement from the solution server 104a.

The solution server 104a receives the confirmation from the user for the requested purchase and the solution server 104a sends (310) the service charging request to the charging server 104b. Further, the charging server 104b makes (312) a special charge call with signaling that comprises the mobile number of the user and the charge number to the MSC 105 through the ISUP/IP. In an embodiment, the charging server 104b makes a special charge call through IP to different network nodes of the operator. For example, the network nodes may include the SDP, the IN, a prepaid platform or the like. The charging server 104b processes the service charging request in coordination with the network operator for charge deduction.

The MSC 105 identifies (314) the charge number that is present within the signaling message and processes (316) the charging request in coordination with charging server 104b and the network operator billing server.

The network operator of the user charges (318) according to the type of the subscription of the user using the standard charging mechanism for prepaid and post paid subscription.

The solution server 104a informs (320) the content provider server 102 to deliver the selected content to the user.

In an embodiment, the charging server 104b can support a plurality interfaces which include but may not be limited to GSMA One API, HTTP, IP, VXML, CCXML, TWSS, SDP, UCIP, TPCGs charging gateways, financial services, mobile payment gateway, online banking, online wallet, mobile wallet and cash cards and the like. The charging server 104b can receive the charging call on any of the above mentioned interfaces for charging to user to purchase the content.

In an embodiment, the server initiates charging procedure with other SS7 protocols such as INAP, MAP/CAP, Diameter, RADIUS and the like.

In an embodiment, the agent 103 can be configured to monitor delivery of the content from the content provider server 102 to the user.

In an embodiment, the agent 103 continuously monitors (322) deliver of the content from the content provider server 102 to the user.

The various actions in method 300 may be performed in the order presented, in a different order or simultaneously. Further, in some embodiments, some actions listed in FIG. 3 may be omitted.

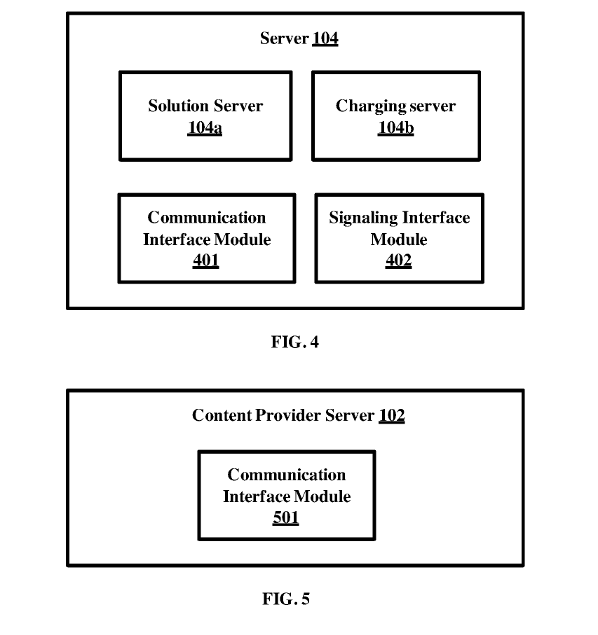

FIG. 4 illustrates a block diagram with various modules in the server, as disclosed in the embodiments herein. As depicted in FIG. 4, the server 104 includes the solution server 104a, the charging server 104b, a communication interface module 401 and a signaling interface module 402. The solution server 104a provides the charging information related to the selected content and the charges associated the selected content. The solution server 104a requests the explicit consent from the user for processing the charge for the selected content. Upon the confirmation from user, the solution server 104 are directs the service charging request to the charging server 104b.

The charging server 104b receives the charging request from the solution server 104a and makes a special charge call with signaling that comprises the mobile number of the user and a charge number to the MSC 105 of the user. In an embodiment, the charging server 104b makes a special charge call through IP to different network nodes of the operator. For example, the network nodes may include the SDP, an Intelligent Network (IN), a prepaid platform or the like. The charging server 104b processes the service charging request in coordination with the network operator for charge deduction.

The communication interface module 401 communicates with the network operators through signaling communication using a variety of protocols. In an embodiment, the server 104 communicates through the communication interface module 401 using the ISUP protocol.

The signaling interface module 402 helps the server 104 to achieve signaling communication with the network operators. In an embodiment, the server 104 may be connected to multiple network operators/wallet service provides/any service providers/financial service providers for providing payment services.

FIG. 5 illustrates a block diagram of a content provider server, according to embodiments as disclosed herein. As depicted in FIG. 5, the content provider server 104 includes a communication interface module 501. The communication interface module 501 communicates with the server 104 through signaling communication using a variety of protocols. In an embodiment, the content provider server 102 communicates with the server 104 through the communication interface module 401 using the IP.

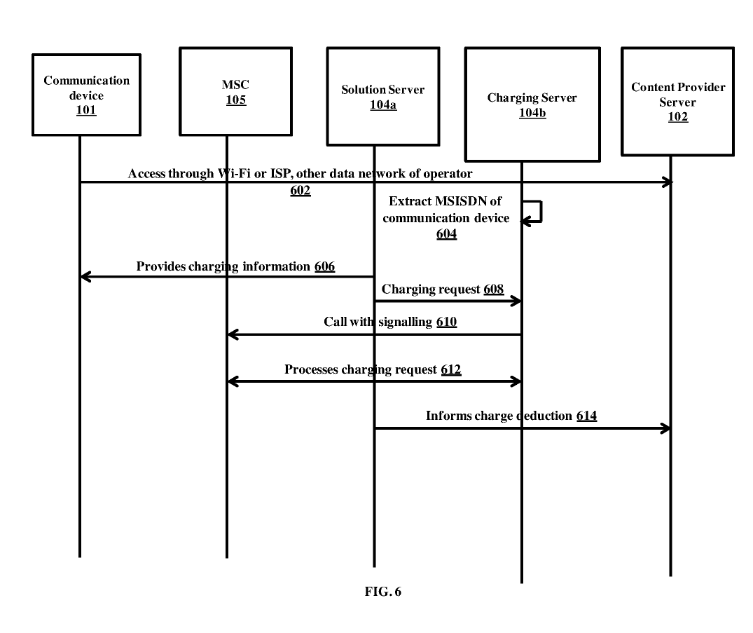

FIG. 6 is a sequence diagram illustrating a procedure of charging the user to purchase the content, according to the embodiments as disclosed herein. The user of the communication device 101 accesses (602) the content from the content provider server 102 through a communication network other than the data communication of the operator.

When the user selects the content to purchase and clicks on the call or buy option, the communication device 101 triggers the charging call to the charging server 104b. The charging server 104b receives the charging call and extracts (604) the MSISDN of the communication device 101.

The solution server 104a provides (606) the charging information to the user regarding the selected content and the charge associated with the selected content. In an example, the solution server 104a announces the purchase of the selected content and allows the user to input the unique number for purchasing the service through the application. In an example, the solution server 104a displays the charging information to the user on the communication device 101.

In an embodiment, the user is requested to provide the consent or the confirmation to avail the requested purchase by inputting the unique number which is associated with the selected content. In an embodiment, the user provides the confirmation to the requested purchase by means of DTMF inputs, Voice Input (Biometric), USSD, OTP SMS, and so on. In an embodiment, the user may create his/her own PIN for providing the confirmation to the selected content. Further, the user may be provided with a default PIN for confirming the selected content for purchase.

In an embodiment, the solution server 104a requests the consent or the confirmation from the user by providing the announcement to the user to enter the PIN to confirm the selected content for purchase. For example, when the user is identified as a frequent user (the frequent user is the user who avails the service/content frequently), the solution server 104a plays announcement to the frequent user to enter the PIN to confirm the selected content for purchase.

In an embodiment, the solution server 104b requests the user for the consent by displaying the WAP/Web page in which the user has to input the digit/number displayed on the WAP/Web page.

The solution server 104a, upon receiving the confirmation from the user, sends (608) the charging request for the selected content to the charging server 104b. Further, the charging server 104b makes (610) the special charge call with signaling that comprises the mobile number of the user and the charge number to the network operator the user. In an embodiment, the charging server 104b makes the special charge call through IP to different network nodes of the operator. For example, the network nodes may include SDP, IN, a prepaid platform or the like. The charging server 104b processes the service charging request in coordination with the network operator for charge deduction.

The network operator identifies the charge number that is present within the signaling message and processes (612) the charging request in coordination with charging server 104b and the network operator billing server.

The network operator charges the user according to the type of the subscription of the user using the standard charging mechanism for prepaid and post paid subscription.

The solution server 104a informs (614) the content provider server 102 regarding charge deduction and the content provider server 102 delivers (618) the selected content to the user.

The embodiments disclosed herein can be implemented through at least one software program running on at least one hardware device and performing network management functions to control the elements. The elements shown in FIGS. 1, 2, 4, 5, and 6 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A system for charging a user to purchase content, the system comprises: an agent, a content provider server, a communication device, a Mobile Switching Center (MSC) and a server
wherein said server is configured to:
extract a Mobile Station International Subscriber Directory Number (MSISDN) of a communication device, wherein said communication device accesses a content provider server to purchase said content through a communication network other than data communication of an operator of said communication device;
obtain a confirmation from said user to purchase said content;
initiate a charging procedure with one of said MSC of said MSISDN and at least one interface after obtaining said confirmation from said user; and
charge said user based on said charging procedure.

2. The system of claim 1, wherein said server is configured to extract said MSISDN of said communication device by:
receiving an event on said content from said user of said communication device; and
extracting said MSISDN and details of said online content.

3. The system of claim 1, wherein said server is configured to obtain confirmation from said user to purchase said online content by:
providing charging information to said user, wherein said charging information corresponds to said content; and
obtaining said confirmation from said user to purchase said content.

4. The system of claim 1, wherein said server is configured to initiate said charging procedure with said MSC using Integrated Services Digital Network (ISDN) User Part (ISUP) Protocol.

5. The system of claim 1, wherein at least one said interface comprises: Global System for Mobile communication Association (GSMA) One Application Programming Interface (one API), Hyper Text Transfer Protocol (HTTP), Internet Protocol (IP), Voice Extensible Markup Language (VXML), Call Control XML (CCXML), User Communication Integration Protocol (UCIP), Telecom Web Services Server (TWSS), Third Party Consent Gateways (TPCGs) and Service Delivery Platform (SDP), charging gateways, financial services, mobile payment gateway, online banking, online wallet, mobile wallet and cash cards.

6. The system of claim 1, wherein said server is further configured to initiate said charging procedure with other Signaling System No. 7 (SS7) protocols.

7. The system of claim 1, wherein said agent is present in said content provider server, wherein said agent is configured to communicate with at least one of: said content provider server, said server and said communication device.

8. The system of claim 1, wherein said agent is configured to monitor delivery of said content from said content provider server to said user.

9. The system of claim 1, wherein said content provider server is one of: a Wireless Application Protocol (WAP) server and a Web server.

10. A method of charging a user for purchasing content, the method comprising:
extracting a Mobile Station International Subscriber Directory Number (MSISDN) of a communication device by a server, wherein said communication device accesses a content provider server to purchase said online content through a communication network other than data communication of an operator of said communication device;
obtaining a confirmation from said user to purchase said content;
initiating a charging procedure with one of a Mobile Switching Center (MSC) of said MSISDN, and at least one interface after obtaining said confirmation from said user; and
charging said user based on said charging procedure.

11. The method of claim 10, wherein extracting said MSISDN of said communication device comprises:
receiving an event on said content from said user of said communication device; and
extracting said MSISDN and details of said online content

12. The method of claim 10, wherein obtaining confirmation from said user to purchase said content comprises:
providing charging information to said user, wherein said charging information corresponds to said content; and
obtaining said confirmation from said user to purchase said content.

13. The method of claim 10, wherein said charging procedure is initiated with said MSC using Integrated Services Digital Network (ISDN) User Part (ISUP) protocol.

14. The method of claim 10, wherein said at least one interface comprises: Global System for Mobile communication Association (GSMA) One Application Programming Interface (one API), Hyper Text Transfer Protocol (HTTP), Internet Protocol (IP), Voice Extensible Markup Language (VXML), UCIP, Call Control XML (CCXML), Telecom Web Services Server (TWSS), User Communication Integration Protocol (UCIP) and Service Delivery Platform (SDP), TPCGs and charging gateways, financial services, mobile payment gateway, online banking, online wallet, mobile wallet and cash cards.

15. The method of claim 10, wherein said server initiates said charging procedure with other Signaling System No. 7 (SS7) protocols.

16. The method of claim 10, wherein said agent is present in said content provider server, wherein said agent communicates with at least one of: said content provider server, said server and said communication device.

17. The method of claim 10, wherein said agent monitors delivery of said content from said content provider server to said user.

18. The method of claim 10, wherein said content provider server is one of: a Wireless Application Protocol (WAP) server and a Web server.
